(19) United States
(12) Patent Application Publication
(10) Pub. No.: US 2008/0101463 A1
(43) Pub. Date: May 1, 2008

(54) METHOD AND APPARATUS FOR DECODING SUBSCREEN IN PORTABLE TERMINAL

(75) Inventor: Byoung-Hee LEE, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/925,523

(22) Filed: Oct. 26, 2007

(30) Foreign Application Priority Data
Oct. 27, 2006 (KR) 2006-0105320

(51) Int. Cl. H04N 7/26

(52) U.S. Cl. 375/240.02; 375/E07.105

(57) ABSTRACT

Provided are a method and an apparatus for decoding a subscreen in a portable terminal. The method includes determining whether a frame for the subscreen is an index (I), bi-directional (B), or predicted (P) frame; measuring an average motion vector of each frame checked as one of the B and P frames; determining a threshold value for determining similarity using a predetermined number of measured average motion vectors; and comparing the average motion vector of the each frame with the threshold value to determine whether the each frame is to be decoded.

### PRIORITY

This application claims priority under 35 U.S.C. § 119 to an application filed in the Korean Intellectual Property Office on Oct. 27, 2006, entitled “Method And Apparatus For Decoding Subscreen in Portable Terminal” and assigned Serial No. 2006-105320, the contents of which are incorporated herein by reference.

### BACKGROUND OF THE INVENTION

1. Field of the Invention

The present invention relates generally to a method and an apparatus for decoding a subscreen in a portable terminal, and in particular, to a method and an apparatus for determining whether each frame is to be decoded using a motion vector of each frame to be displayed in a Picture In Picture (PIP).

2. Description of the Related Art

A Picture In Picture (PIP) function is a multi display function of playing a secondary screen in a main screen. In other words, the multi display function is to express two or more video signals in a single display device in order to allow a user to view a plurality of videos. Here, the secondary screen displayed in the main screen is called a PIP screen or a subscreen.

Research has been conducted to provide PIP functions in portable terminals. However, since such a portable terminal cannot provide a method of processing a subscreen, the subscreen must be decoded and displayed using the method of decoding and displaying a main screen. Thus, the portable terminal in order to support a PIP function of simultaneously displaying a main screen and a subscreen requires a decoder, which has higher performance than when displaying only a main screen. For example, the decoder must have a QVGA (Quarter Video Graphics Array) 60FPS (Frame Per Second) performance or more in order to display a QVGA video with 30 frames per second in a PIP mode.

Since the subscreen is generally smaller than the main screen, a user has difficulty differentiating changes of the subscreen compared to changes of the main screen. Accordingly, the simultaneous display of the main screen and the subscreen in the portable terminal causes unnecessary overhead in the decoder and the display module.

### SUMMARY OF THE INVENTION

An aspect of the present invention is to substantially solve at least the above problems and/or disadvantages and to provide at least the advantages below. Accordingly, an aspect of the present invention is to provide a method and an apparatus for decoding a subscreen in a portable terminal.

Another aspect of the present invention is to provide a method and an apparatus for reducing overhead in a portable terminal by controlling if a subscreen is to be decoded based on similarity of the subscreen.

A further aspect of the present invention is to provide a method and an apparatus for determining if a subscreen is to be decoded and displayed using a motion vector in a portable terminal.

According to one aspect of the present invention, there is provided a method of decoding a subscreen in a portable terminal, including checking whether a frame for the subscreen is an index (I), bi-directional (B), or predicted (P) frame; measuring the average motion vector of each frame checked as one of the B and P frames; determining a threshold value for determining similarity using a predetermined number of measured average motion vectors; and comparing the average motion vector of each frame with the threshold value to determine if each frame is to be decoded.

According to another aspect of the present invention, there is provided an apparatus for decoding a subscreen in a portable terminal, including a frame determiner for checking whether a frame for the subscreen is an I, B, or P frame; a similarity calculator measuring an average motion vector of each frame checked as one of the B and P frames; a threshold value calculator for determining the threshold value for determining similarity using a predetermined number of measured average motion vectors; and a decoding determiner for comparing the average motion vector of the each frame with the threshold value to determine if each frame is to be decoded.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a portable terminal according to the present invention;

FIG. 2 is a detailed block diagram of a subscreen decoder in a portable terminal according to the present invention;

FIG. 3 is a flowchart of a method of decoding a subscreen in a portable terminal according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention provides a method and an apparatus for determining whether each frame to be displayed in a subscreen is to be decoded and displayed, using a motion vector in a Picture In Picture (PIP) mode in a portable terminal.

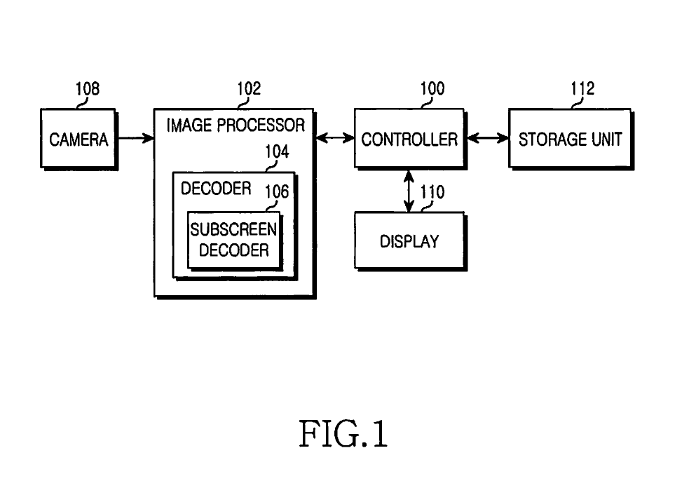

Referring to FIG. 1, the portable terminal includes a controller 100, an image processor 102, a camera 108, a display 110, and a storage unit 112. Here, the image processor 102 includes a decoder 104 having a subscreen decoder 106.

Controller 100 controls the overall operation of the portable terminal, i.e., processes and controls functions for voice and data communications. According to the present invention, controller 100 processes and controls functions for determining whether frames for a subscreen are to be decoded and displayed according to similarity of the frames in a Picture In Picture (PIP) mode.

Image processor 102 is also referred to as an image coder-decoder (CODEC). Image processor 102 includes an encoder (not shown) to code an image signal input from camera 108 using a set method and provide the coded image signal to controller 100. Image processor 102 also includes decoder 104 to decode coded frame image data into original frame image data and provide the original frame image data to controller 100.

Decoder 104 includes a main screen decoder (not shown) and subscreen decoder 106 to support a PIP function. The main screen decoder decodes frame image data for a main screen. Subscreen decoder 106 decodes frame image data for the subscreen. Decoder 104 determines if the coded frame image data is a frame for the main screen or the subscreen and provides the determination result to the main screen decoder or subscreen decoder 106.

Subscreen decoder 106 receives a frame for the subscreen, determines whether the frame is to be decoded according to similarity of frames, and decodes each frame according to the determination result.

Display 110 displays state information and limited numerical letters generated during an operation of the portable terminal. In particular, according to the present invention, display 110 is controlled by the controller 100 to display decoded frames for the subscreen in a predetermined area.

Storage unit 112 may be a read only memory (ROM), a random access memory (RAM), or a flash ROM. Storage unit 112 stores micro codes of a program for the processing and controlling of controller 100, various kinds of reference data, temporary data generated during executions of various programs, and updatable storage data. In particular, according to the present invention, storage unit 112 may store coded image frame data.

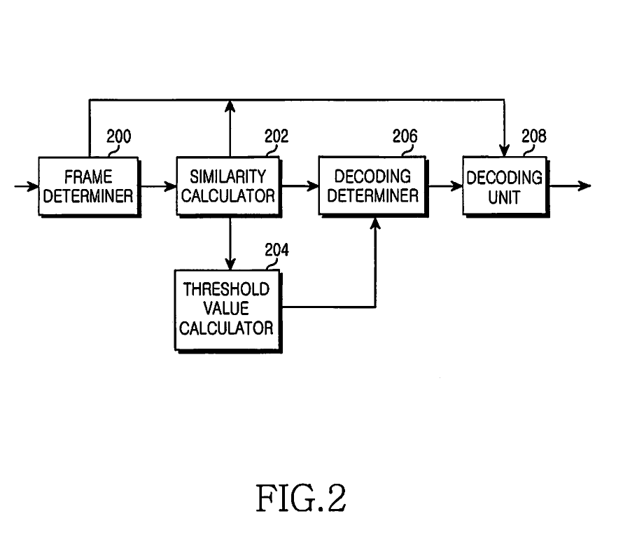

Referring to FIG. 2, decoder 104 of the portable terminal includes a frame determiner 200, a similarity calculator 202, a threshold value calculator 204, a decoding determiner 206, and a decoding unit 208.

Frame determiner 200 receives a frame on which a motion compensation operation has been performed, checks whether the frame is an index (I), predicted (P), or bi-directional (B) frame, outputs the I frame to decoding unit 208, and outputs the P or B frame to similarity calculator 202. Here, the I frame is a frame which has complete data of one frame and thus is compressed regardless of other frames and is also an index of the P and B frames. The P frame is a frame, which is compressed by coding only data that has not overlapped with a previous frame. The B frame is a frame, which is compressed using information of previous and subsequent frames.

Similarity calculator 202 receives the frame from frame determiner 200, measures an average motion vector indicating similarity between the received frame and a previous frame, and outputs the average motion vector to threshold value calculator 204. Here, similarity calculator 202 divides the received frame into 4*4 microblocks, calculates motion vectors of the 4*4 microblocks using information of the previous frame, and calculates an average of the motion vectors in order to measure an average motion vector of the frame. Similarity calculator 202 counts the number of frames input from frame determiner 200, outputs first through K^{th} frames to decoding unit 208, and outputs a frame subsequent to the K^{th} frame to decoding determiner 206. Here, similarity calculator 202 outputs the frame subsequent to the K^{th} frame together with an average motion vector of the corresponding frame to decoding determiner 206.

Threshold value calculator 204 receives an average motion vector of each frame from similarity calculator 202, sets a threshold value for determining similarity using average motion vectors of the K frames, and outputs the set threshold value to decoding determiner 206. Here, the threshold value is to determine whether a corresponding frame is to be decoded according to similarity of the corresponding frame to previous frames and may be set according to the similarity of a frame to all frames to be decoded. For example, if 50% of all frames are to be decoded, and the rest are not to be decoded but are to be discarded, an intermediate average motion vector of the average motion vectors may be set to a threshold value. Here, threshold value calculator 204 continuously updates the threshold value using most recently input K average motion vectors. In other words, threshold value calculator 204 sets the threshold value using average motion vectors of first through K^{th} frames, and if an average motion vector of the K+1^{th} frame is input, updates the set threshold value using average motion vectors of second through K+1^{th} frames. This is to allow the threshold value to be appropriate for recently input frames in order to lower an error rate.

Decoding determiner 206 compares an average motion vector input from similarity calculator 202 with the threshold value input from threshold value calculator 204 to determine if the corresponding frame is to be decoded. If the average motion vector of the frame is smaller than the threshold value, decoding determiner 206 determines that the frame is similar to a previous frame and disallows the frame to be decoded. If the average motion vector of the frame is greater than or equal to the threshold value, decoding determiner 206 determines that the frame is not similar to the previous frame and outputs the frame to decoding unit 208. Here, the frame, which is not decoded may be used as a reference frame (previous frame) to other frames, and thus decoding determiner 206 temporarily stores the frame in a buffer and disallows the frame to be decoded and displayed.

Decoding unit 208 decodes a frame input from frame determiner 200 or decoding determiner 206 and outputs the decoded frame to controller 100.

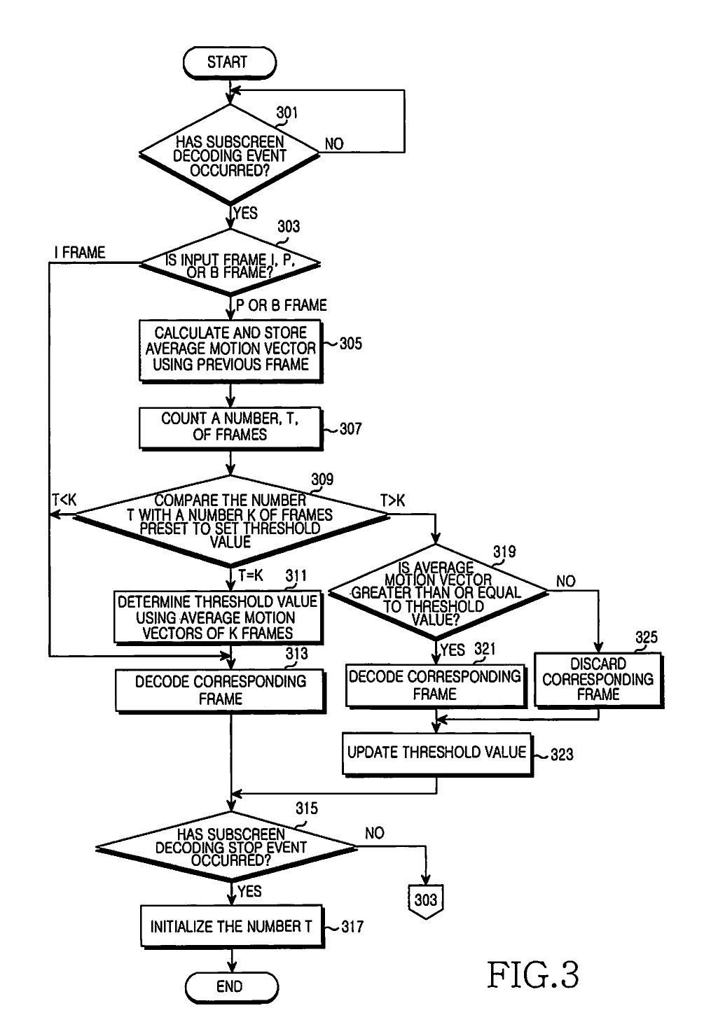

Referring to FIG. 3, in step 301, the portable terminal checks if a subscreen decoding event has occurred, to display an image on a subscreen. If the subscreen decoding event has occurred in step 301, the portable terminal determines if a frame input to a decoder is an I, P, or B frame in step 303. If the input frame is the I frame in step 303, the portable terminal goes to step 313 to decode the I frame and display the decoded I frame in a predetermined area of the display 110, and then proceeds to step 315.

If the input frame is the P or B frame in step 303, the portable terminal proceeds to step 305 to calculate and store an average motion vector of the input frame using information of a previous frame (or previous and subsequent frames). Here, the portable terminal may divide the corresponding frame into 4*4 microblocks, calculate motion vectors of the 4*4 microblocks using information of the previous frame, and calculate an average of the motion vectors to calculate an average motion vector of the corresponding frame. In step 307, the portable terminal initializes a number, T, of P and B frames, which has been input up to now, and increases the number T by 1.

In step 309, the portable terminal compares the number T with a number, K, of frames preset to set a threshold value. If the number T is smaller than the number K in step 309, the portable terminal proceeds to step 313 to decode the input frame and display the decoded frame in the predetermined area of display 110, and then proceeds to step 315. If the number T is equal to the number K in step 309, the portable terminal goes to step 311 to determine a threshold value using average motion vectors of K frames which have been input up to now, decodes the input frame in step 313, displays the decoded frame in the predetermined area of display 110, and goes to step 315.

If the number T is greater than the number K in step 309, the portable terminal goes to step 319 to compare if the average motion vector of the input frame is greater than or equal to the determined threshold value. If the average motion vector of the input frame is smaller than the threshold value in step 319, the portable terminal determines that the input frame is similar to the previous frame, discards the input frame in step 325, and goes to step 323.

If the average motion vector of the input frame is greater than or equal to the threshold value in step 319, the portable terminal determines that the input frame is not similar to the previous frame, decodes the input frame and displays the decoded frame in the predetermined area of display 110 in step 321. Thereafter, the portable terminal updates the threshold value based on the average motion vector of the input frame in step 323 and then goes to step 315.

In step 315, the portable terminal checks if a subscreen decoding stop event has occurred. If the subscreen decoding stop event has not occurred in step 315, the portable terminal returns to step 303 to perform steps subsequent to step 303. If the subscreen decoding stop event has occurred in step 315, the portable terminal goes to step 317 to initialize the number T. The portable terminal ends the process of the present invention.

In accordance with the present invention as described above, a portable terminal can determine whether each frame to be displayed on a subscreen is to be decoded and displayed using a motion vector in a PIP mode. Thus, the portable terminal cannot decode and display frames similar to a previous or subsequent frame to reduce overheads of a decoder and a display. As a result, decoding efficiency for a main screen can be improved.

Alternate embodiments of the present invention can also comprise computer readable codes on a computer readable medium. The computer readable medium includes any data storage device that can store data that can be read by a computer system. Examples of a computer readable medium include magnetic storage media (such as ROM, floppy disks, and hard disks, among others), optical recording media (such as CD-ROMs or DVDs), and storage mechanisms such as carrier waves (such as transmission through the Internet). The computer readable medium can also be distributed over network coupled computer systems so that the computer readable code is stored and executed in a distributed fashion. Also, functional programs, codes, and code segments for accomplishing the present invention can be construed by programmers of ordinary skill in the art to which the present invention pertains.

While the invention has been shown and described with reference to certain preferred embodiments thereof, it will be understood by those skilled in the art that various changes in form and details may be made therein without departing from the spirit and scope of the invention as further defined by the appended claims.

What is claimed is:

1. A method of decoding a subscreen in a portable terminal, comprising:
determining whether a frame for the subscreen is one of an index (I), bi-directional (B), or predicted (P) frame;
measuring an average motion vector of each frame determined to be one of the B and P frames;
determining a threshold value for determining similarity using a predetermined number of measured average motion vectors; and
comparing the average motion vector of the each frame with the threshold value to determine if the each frame is to be decoded.

2. The method of claim 1, wherein if the average motion vector of the corresponding frame is greater than or equal to the threshold value, the determination as to whether the each frame is to be decoded comprises decoding the corresponding frame.

3. The method of claim 1, wherein if the average motion vector of the corresponding frame is smaller than the threshold value, the determination as to whether the each frame is to be decoded comprises disallowing the corresponding frame to be decoded.

4. The method of claim 1, wherein the threshold value is updated using a predetermined number of most recently measured average motion vectors.

5. The method of claim 1, wherein the I frame is decoded.

6. An apparatus for decoding a subscreen in a portable terminal, comprising:
a frame determiner determining whether a frame for the subscreen is one of an I, B, and P frame;
a similarity calculator measuring an average motion vector of each frame determined as one of the B and P frames;
a threshold value calculator determining a threshold value for determining similarity using a predetermined number of measured average motion vectors; and
a decoding determiner comparing the average motion vector of the each frame with the threshold value to determine whether the each frame is to be decoded.

7. The apparatus of claim 6, wherein if the average motion vector of the corresponding frame is greater than or equal to the threshold value, the decoding determiner determines that the corresponding frame is to be decoded, and if the average motion vector of the corresponding frame is smaller than the threshold value, determines that the corresponding frame is not to be decoded.

8. The apparatus of claim 6, wherein the threshold value is updated using a predetermined number of most recently measured average motion vectors.

9. The apparatus of claim 6, wherein the I frame is decoded.

10. A computer-readable recording medium having recorded thereon a program for adding a code prior to a calling number in a mobile communication terminal, comprising:
a first code segment, for determining whether a frame for the subscreen is one of an index (I), bi-directional (B), or predicted (P) frame;
a second code segment, for measuring an average motion vector of each frame determined to be one of the B and P frames;
a third code segment, for determining a threshold value for determining similarity using a predetermined number of measured average motion vectors; and
a fourth code segment, for comparing the average motion vector of the each frame with the threshold value to determine if the each frame is to be decoded.
